(19) United States
(12) Patent Application Publication
(10) Pub. No.: US 2022/0081344 A1
(43) Pub. Date: Mar. 17, 2022

(54) DEVICE AND METHOD FOR PRODUCING FINE GLASS PARTICLE DEPOSITED BODY

(71) Applicant: SUMITOMO ELECTRIC INDUSTRIES, LTD., Osaka-shi, Osaka (JP)

(72) Inventor: Tomomi MORIYA, Osaka-shi, Osaka (JP)

(73) Assignee: SUMITOMO ELECTRIC INDUSTRIES, LTD., Osaka-shi, Osaka (JP)

(21) Appl. No.: 17/299,439

(22) PCT Filed: Dec. 4, 2019
(86) PCT No.: PCT/JP2019/047458

§ 371 Date: Jun. 3, 2021

(30) Foreign Application Priority Data
Dec. 4, 2018 (JP) 2018-227115

(51) Int. Cl. C03B 37/014

(52) U.S. Cl. CPC C03B 37/0142; C03B 37/01406; C03B 2207/87; C03B 2207/62; C03B 2207/70; C03B 2207/34

(57) ABSTRACT

Provided is a device for producing a fine glass particle deposited body by depositing fine glass particles on a starting rod disposed within a reaction vessel, the device being provided with: a burner for synthesizing fine glass particles by jetting out a source gas; a transfer mechanism to which the burner is disposed and which causes the burner to move backward in association with an increase in the diameter of a fine glass particle deposited body; a vaporizer which is disposed to the transfer mechanism so as to be moved backward integrally with the burner and which converts a liquid siloxane into a source gas through vaporization; piping through which the source gas is fed from the vaporizer to the burner; and a heating mechanism which heats up the piping with a heating temperature of at least 230° C.

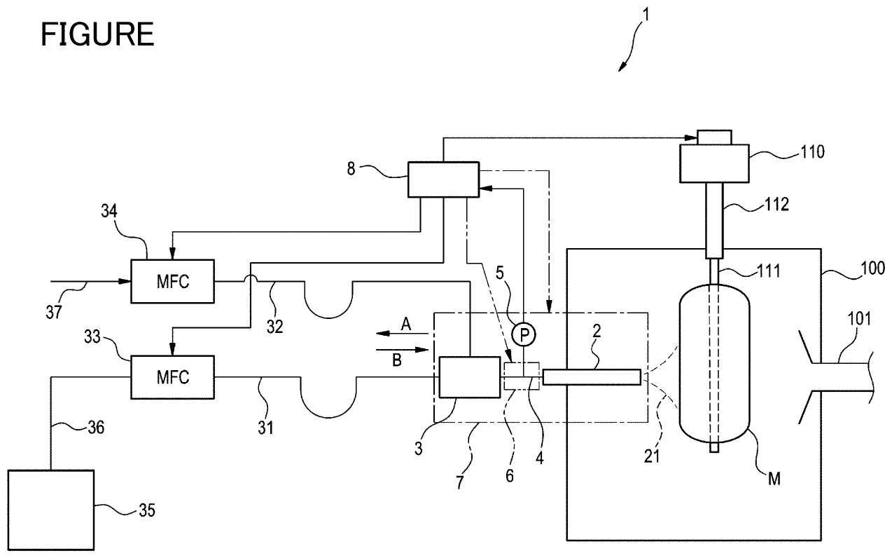

### TECHNICAL FIELD

The present disclosure relates to a device for manufacturing a glass fine particle deposited body, and a method therefor.

This application is based upon and claims the benefit of priority from Japanese Patent Application No. 2018-227115, filed on Dec. 4, 2018, the entire contents of which are incorporated herein by reference.

### BACKGROUND ART

Patent Literature 1 describes a burner for manufacturing a glass fine particle deposited body that forms the glass fine particle deposited body by using siloxane as a raw material and a method for manufacturing the glass fine particle deposited body.

Patent Literature 2 describes that a burner is retracted as a glass fine particle deposited body grows and a diameter thereof increases.

### CITATION LIST

### Patent Literature

Patent Literature 1: JP-A-2014-224007

Patent Literature 2: JP-A-2012-62203

### SUMMARY OF INVENTION

According to one aspect of the present disclosure, there is a device for manufacturing a glass fine particle deposited body, which manufactures the glass fine particle deposited body by depositing a glass fine particle on a starting rod disposed in a reaction vessel, the device including:

a burner that sprays raw material gas to synthesize the glass fine particle;

a moving mechanism in which the burner is disposed and the burner is retracted as a diameter of the glass fine particle deposited body increases;

a vaporizer that is disposed in the moving mechanism to be integrally retracted with the burner, and vaporizes liquid siloxane to produce the raw material gas;

a pipe that supplies the raw material gas from the vaporizer to the burner; and

a heating mechanism that heats the pipe at heating temperature of 230° C. or higher.

According to one aspect of the present disclosure, there is a method for manufacturing a glass fine particle deposited body, which manufactures the glass fine particle deposited body by depositing a glass fine particle on a starting rod disposed in a reaction vessel, the method including:

a vaporization step of vaporizing liquid siloxane by a vaporizer to produce raw material gas;

a heating step of heating a pipe that supplies the vaporized raw material gas from the vaporizer to a burner at heating temperature of 230° C. or higher; and

a deposition step of arranging the burner and the vaporizer in a moving mechanism, integrally retracting the burner and the vaporizer by the moving mechanism as a diameter of the glass fine particle deposited body increases, and depositing the glass fine particle synthesized from the raw material gas sprayed from the burner on the starting rod.

### BRIEF DESCRIPTION OF DRAWINGS

FIGURE is a schematic configuration diagram of a device for manufacturing a glass fine particle deposited body according to an embodiment of the present disclosure.

### DESCRIPTION OF EMBODIMENTS

### Technical Problem

When a glass fine particle deposited body is formed by using siloxane, siloxane is vaporized and then the vaporized siloxane is supplied to a burner, but a boiling point of siloxane is higher than that of silicon tetrachloride which is used as a related-art raw material, such that raw material gas is cooled in the burner and in a pipe that supplies the raw material to the burner, and is easily liquefied. Therefore, for example, in Patent Literature 1, the burner is heated and the pipe that supplies the vaporized raw material gas is also heated to prevent liquefaction.

However, since a length of the pipe that supplies the raw material gas is long, it is difficult to maintain temperature so that the temperature is equal to or higher than the boiling point of siloxane over the whole length of the pipe. When the temperature of the pipe is raised too high, siloxane becomes a particle due to polymerization reaction, which causes clogging of the pipe.

When the glass fine particle deposited body grows and a diameter thereof increases, a distance between the burner and a deposition surface changes, and temperature of the deposition surface and deposition efficiency change. Therefore, as described in Patent Literature 2, for example, it is required to retract the burner as the diameter of the glass fine particle deposited body increases, and it is also required to prevent the liquefaction and clogging of the pipe that supplies the raw material gas in a mechanism that retracts the burner.

An object of the present disclosure is to provide a device for manufacturing a glass fine particle deposited body and a method therefor capable of suppressing liquefaction of a raw material in a pipe supplied to a burner and clogging of the pipe.

### Advantageous Effects of the Present Disclosure

According to a device for manufacturing a glass fine particle deposited body and a method therefor according to the present disclosure, it is possible to prevent liquefaction of a raw material in a pipe supplied to a burner and clogging of the pipe.

### Description of Embodiments of the Present Disclosure

First, embodiments of the present disclosure will be listed and described.

(1) According to one aspect of the present disclosure, there is a device for manufacturing a glass fine particle deposited body, which manufactures the glass fine particle deposited body by depositing a glass fine particle on a starting rod disposed in a reaction vessel, the device including:

a burner that sprays raw material gas to synthesize the glass fine particle;

a moving mechanism in which the burner is disposed and the burner is retracted as a diameter of the glass fine particle deposited body increases;

a vaporizer that is disposed in the moving mechanism to be integrally retracted with the burner, and vaporizes liquid siloxane to produce the raw material gas;

a pipe that supplies the raw material gas from the vaporizer to the burner; and

a heating mechanism that heats the pipe at heating temperature of 230° C. or higher.

According to the above-described configuration, since the burner and the vaporizer are disposed to be integrally retracted in the moving mechanism, a length of the pipe that supplies the vaporized raw material gas from the vaporizer to the burner may be shortened. As a result, since an area to be heated at the heating temperature of 230° C. or higher by the heating mechanism may be narrowed, the pipe that supplies the vaporized raw material to the burner is easily kept at an appropriate temperature, and it is possible to prevent liquefaction of the raw material in the pipe supplied to the burner and clogging of the pipe.

(2) The device for manufacturing the glass fine particle deposited body according to (1) may further include a pressure sensor that measures pressure of the raw material gas in the pipe.

According to the above-described configuration, the pressure of the raw material gas in the pipe is measured by the pressure sensor, thereby it is possible to determine whether the raw material gas is liquefied by fluctuation of the pressure thereof and to control the heating temperature.

(3) According to one aspect of the present disclosure, there is a method for manufacturing a glass fine particle deposited body, which manufactures the glass fine particle deposited body by depositing a glass fine particle on a starting rod disposed in a reaction vessel, the method including:

a vaporization step of vaporizing liquid siloxane by a vaporizer to produce raw material gas;

a heating step of heating a pipe that supplies the vaporized raw material gas from the vaporizer to a burner at heating temperature of 230° C. or higher; and

a deposition step of arranging the burner and the vaporizer in a moving mechanism, integrally retracting the burner and the vaporizer by the moving mechanism as a diameter of the glass fine particle deposited body increases, and depositing the glass fine particle synthesized from the raw material gas sprayed from the burner on the starting rod.

According to the above-described method, since the burner and the vaporizer are integrally retracted by the moving mechanism, a length of the pipe that supplies the vaporized raw material gas from the vaporizer to the burner may be shortened. As a result, since an area to be heated at the heating temperature of 230° C. or higher by the heating mechanism may be narrowed, the pipe that supplies the vaporized raw material to the burner may be easily kept at an appropriate temperature, and it is possible to prevent liquefaction of the raw material in the pipe supplied to the burner and clogging of the pipe.

(4) The method for manufacturing the glass fine particle deposited body according to (3), where

it may be determined whether the raw material gas is liquefied by measuring fluctuation of pressure of the vaporized raw material gas with a pressure sensor, and the heating temperature may be controlled based upon a determination result.

According to the above-described method, it may be determined whether the raw material gas is liquefied by measuring the fluctuation of the pressure of the vaporized raw material gas with the pressure sensor, and the heating temperature may be controlled based upon the determination result.

### Details of Embodiments of the Present Disclosure

A specific example of a device for manufacturing a glass fine particle deposited body and a method therefor according to an embodiment of the present disclosure will be described with reference to the drawings.

The present invention is not limited to the examples, but is indicated by the scope of the claims, and is intended to include all the modifications within the meaning equivalent to the scope of the claims and within the scope thereof.

FIGURE is a schematic configuration diagram illustrating an example of a device for manufacturing a glass fine particle deposited body according to an embodiment of the present disclosure.

As illustrated in FIGURE, a manufacturing device 1 includes a burner 2, a vaporizer 3, a pipe 4, a pressure sensor 5, a heating mechanism 6, a moving mechanism 7, and a control unit 8. The manufacturing device 1 is a device for manufacturing a glass fine particle deposited body M by depositing a glass fine particle 21 on a starting rod 111 disposed in a reaction vessel 100.

The burner 2 sprays raw material gas to synthesize the glass fine particle 21. For example, the burner 2 sprays vaporized raw material gas into an oxyhydrogen flame generated by combustion supporting gas (oxygen) and combustible gas (hydrogen), thereby causing oxidation reaction to synthesize the glass fine particle 21. The burner 2 sprays the synthesized glass fine particle 21 toward the starting rod 111. The burner 2 is formed of a metal material, for example, stainless steel or the like having excellent corrosion resistance.

As the raw material gas, vaporized liquid siloxane is used. As siloxane, octamethylcyclotetrasiloxane (OMCTS), the melting point of which is 17.5° C. and the boiling point of which is 175° C., decamethylcyclopentasiloxane (DMCPS), the melting point of which is −38° C. and the boiling point of which is 210° C., hexamethylcyclotrisiloxane, the melting point of which is 64° C. and the boiling point of which is 134° C., hexamethyldisiloxane, the melting point of which is −68° C. and the boiling point of which is 100° C., or the like may be used, and OMCTS is the most preferable.

In FIGURE, a gas supply device that supplies flame forming gas to the burner 2 is omitted.

The vaporizer 3 is a device that vaporizes liquid siloxane to produce gaseous siloxane (the raw material gas). Mass flow controllers (MFCs) 33 and 34 are connected to the vaporizer 3 via tubes 31 and 32. The MFC 33 is a liquid controller for controlling a flow rate of liquid siloxane. The MFC 34 is a controller for controlling a flow rate of carrier gas (nitrogen gas in this example) that carries the raw material gas. The MFC 33 supplies liquid siloxane to the vaporizer 3 via the tube 31. The MFC 34 supplies nitrogen gas to the vaporizer 3 via the tube 32. The tubes 31 and 32 are formed of, for example, a flexible Teflon (registered trademark) tube that is capable of coping with a change in a distance between the MFCs 33 and 34 and the vaporizer 3. A raw material tank 35 in which liquid siloxane is stored is connected to the MFC 33 via a pipe 36. A pipe 37 that supplies the carrier gas is connected to the MFC 34. The MFCs 33 and 34 are electrically connected to the control unit 8.

The pipe 4 is a pipe for guiding the raw material gas vaporized by the vaporizer 3 to the burner 2. The pipe 4 is connected between the vaporizer 3 and the burner 2.

The pressure sensor 5 is a sensor for measuring pressure of the raw material gas in the pipe 4. The pressure sensor 5 is a sensor having high heat resistance and is provided in the pipe 4. The pressure sensor 5 is electrically connected to the control unit 8.

The heating mechanism 6 is a mechanism for heating the pipe 4. The heating mechanism 6 is formed of, for example, a tape heater in which ultrafine stranded wires of a metal heating element and a carbon fibrous surface heating element are covered with a protective material. For example, the tape heater is wrapped around an outer periphery of the pipe 4. When the tape heater is energized, the heating mechanism 6 may heat the pipe 4 at heating temperature of, for example, 230° C. or higher. By heating the pipe 4, siloxane which is the raw material gas is heated to reach boiling point temperature or higher. As a result, the temperature of the raw material gas is maintained so that siloxane in the pipe 4 is not liquefied and does not become a particle by polymerization reaction. The heating mechanism 6 is electrically connected to the control unit 8.

The moving mechanism 7 is a mechanism capable of moving in directions indicated by arrows A and B with respect to the starting rod 111 disposed in the reaction vessel 100. As the moving mechanism 7, for example, a linear motor and a stepping motor that may move linearly may be used. The moving mechanism 7 is electrically connected to the control unit 8.

The burner 2, the vaporizer 3, and the pipe 4 are disposed in the moving mechanism 7. The burner 2, the vaporizer 3, and the pipe 4 are configured to move backward (in the direction of the arrow A) or forward (in the direction of the arrow B) with respect to the starting rod 111 in the reaction vessel 100 integrally with the moving mechanism 7.

In the reaction vessel 100, an exhaust pipe 101 is provided on a side wall facing the burner 2. The exhaust pipe 101 is a pipe that exhausts a given amount of gas, and removes the glass fine particle 21 which is not deposited on the glass fine particle deposited body M and floats in the reaction vessel 100. A rotary traverse device 110 is connected to the starting rod 111 via a support rod 112. The rotary traverse device 110 holds an upper portion of the starting rod 111 by the support rod 112, and reciprocates the starting rod 111 in an axial direction while rotating the starting rod 111 in the reaction vessel 100. The rotary traverse device 110 is electrically connected to the control unit 8.

The control unit 8 controls respective operations of the heating mechanism 6, the moving mechanism 7, the MFCs 33 and 34, the rotary traverse device 110, or the like. For example, the control unit 8 controls the heating mechanism 6 and the MFCs 33 and 34 so that the pressure of the raw material gas becomes given pressure based upon the pressure of the raw material gas measured by the pressure sensor 5. The control unit 8 controls the moving mechanism 7 so that a distance between a deposition surface of the glass fine particle deposited body M and a tip of the burner 2 becomes a given distance. The control unit 8 reciprocates the starting rod 111 along the axial direction thereof while rotating the starting rod 111, thereby controlling the rotary traverse device 110 so that the glass fine particle is uniformly deposited on the deposition surface of the glass fine particle deposited body M.

Next, a method for manufacturing the glass fine particle deposited body using the manufacturing device 1 will be described. In the method for manufacturing the glass fine particle deposited body described below, OMCTS is used as siloxane of the raw material.

<Vaporization Step>

Liquid OMCTS stored in the raw material tank 35 is supplied to the vaporizer 3 by the MFC 33 via the tube 31. Nitrogen gas as carrier gas is supplied to the vaporizer 3 by the MFC 34 via the tube 32, and OMCTS is dropped onto the carrier gas sprayed at a high speed, whereby the liquid OMCTS is vaporized by the vaporizer 3 to generate the raw material gas.

<Heating Step>

The generated raw material gas is supplied from the vaporizer 3 to the burner 2 via the pipe 4. The heating mechanism 6 heats the pipe 4 through which the raw material gas flows at heating temperature of 230° C. or higher. The pressure sensor 5 measures the pressure of the raw material gas in the pipe, and transmits a measured pressure value to the control unit 8. The control unit 8 compares the measured pressure value with a given pressure value, and determines whether the raw material gas is liquefied. The control unit 8 controls the heating temperature of the heating mechanism 6 based upon a determination result. The heating mechanism 6 changes the heating temperature for heating the pipe 4 based upon a heating control signal transmitted from the control unit 8.

The control unit 8 may control the pressure value of the raw material gas by changing a flow rate of the liquid OMCTS supplied from the MFC 33, based upon the measured pressure value. For example, when the measured pressure value is lower than the given pressure value, the flow rate of OMCTS may be increased.

<Deposition Step>

The starting rod 111 reciprocates in the axial direction while rotating by the rotary traverse device 110. The glass fine particle 21 synthesized from the raw material gas sprayed from the burner 2 is deposited on the starting rod 111. As a result, the glass fine particle 21 is deposited on an outer periphery of the starting rod 111, and the glass fine particle deposited body M grows in a radial direction. On the other hand, the burner 2, the vaporizer 3, and the pipe 4 are disposed in the moving mechanism 7 of the manufacturing device 1. As described above, as a diameter of the glass fine particle deposited body M increases, the moving mechanism 7 integrally retracts the burner 2, the vaporizer 3, and the pipe 4 in the direction of the arrow A, such that a distance between the burner 2 and the glass fine particle deposited body M is maintained at a given distance (for example, an almost constant distance). For example, a specific method for doing so is performed as follows. A distance between the tip of the burner 2 and the deposition surface of the glass fine particle deposited body M is measured by a distance sensor or the like (not illustrated). The control unit 8 controls the moving mechanism 7 so that the distance between the tip of the burner 2 and the deposition surface of the glass fine particle deposited body M is maintained at the given distance. The moving mechanism 7 integrally moves the burner 2, the vaporizer 3, and the pipe 4 disposed in the moving mechanism 7 with respect to the glass fine particle deposited body M, based upon a movement control signal transmitted from the control unit 8.

According to the manufacturing device 1 and the manufacturing method of the glass fine particle deposited body as described above, since the burner 2 and the vaporizer 3 are disposed in one moving mechanism 7, the burner 2 and the vaporizer 3 are configured to integrally move (retract) when the moving mechanism 7 moves (retracts). Therefore, since a distance between the vaporizer 3 and the burner 2 does not change, the pipe 4 connecting the vaporizer 3 and the burner 2 is not required to be formed of, for example, a flexible pipe (a tube), and a length of the pipe 4 may be shortened. As a result, since an area to be heated at the heating temperature of 230° C. or higher by the heating mechanism 6 may be narrowed, the pipe 4 that supplies the vaporized raw material gas to the burner 2 is easily kept at an appropriate temperature. Therefore, it is possible to prevent liquefaction of the raw material gas in the pipe 4 from the vaporizer 3 to the burner 2 and clogging of the pipe 4 due to particle formation of the raw material gas.

Since the pressure of the raw material gas in the pipe 4 may be measured by the pressure sensor 5, whether the raw material gas is liquefied may be determined from measured pressure fluctuation. Therefore, the heating temperature of the heating mechanism 6 and the flow rate of siloxane supplied from the MFC 33 may be controlled based upon the pressure fluctuation, thereby it is possible to prevent the liquefaction of the raw material gas in the pipe 4 and the pipe clogging due to the particle formation of the raw material gas.

Hereinabove, while the present invention has been described in detail and with reference to specific embodiments, it is apparent to those skilled in the art that various modifications and corrections may be made without departing from the spirit and scope of the present invention. The number, position, shape, or the like of the above-described components are not limited to the embodiments, and may be changed to the number, position, shape, or the like suitable for performing the present invention.

### REFERENCE SIGNS LIST

1: manufacturing device
2: burner
3: vaporizer
4: pipe
5: pressure sensor
6: heating mechanism
7: moving mechanism
8: control unit
21: glass fine particle
31, 32: tube
33, 34: MFC
35: raw material tank
36, 37: pipe
100: reaction vessel
111: starting rod
M: glass fine particle deposited body

1. A device for manufacturing a glass fine particle deposited body, which manufactures the glass fine particle deposited body by depositing a glass fine particle on a starting rod disposed in a reaction vessel, the device comprising:
a burner that sprays raw material gas to synthesize the glass fine particle;
a moving mechanism in which the burner is disposed and the burner is retracted as a diameter of the glass fine particle deposited body increases;
a vaporizer that is disposed in the moving mechanism to be integrally retracted with the burner, and vaporizes liquid siloxane to produce the raw material gas;
a pipe that supplies the raw material gas from the vaporizer to the burner; and
a heating mechanism that heats the pipe at heating temperature of 230° C. or higher.

2. The device for manufacturing the glass fine particle deposited body according to claim 1, further comprising:
a pressure sensor that measures pressure of the raw material gas in the pipe.

3. A method for manufacturing a glass fine particle deposited body, which manufactures the glass fine particle deposited body by depositing a glass fine particle on a starting rod disposed in a reaction vessel, the method comprising:
arranging a burner and a vaporizer in a moving mechanism;
vaporizing liquid siloxane by the vaporizer to produce raw material gas;
heating a pipe that supplies the vaporized raw material gas from the vaporizer to the burner at heating temperature of 230° C. or higher;
depositing the glass fine particle synthesized from the raw material gas sprayed from the burner on the starting rod; and
integrally retracting the burner and the vaporizer by the moving mechanism as a diameter of the glass fine particle deposited body increases.

4. The method for manufacturing the glass fine particle deposited body according to claim 3, wherein
it is determined whether the raw material gas is liquefied by measuring fluctuation of pressure of the vaporized raw material gas with a pressure sensor, and
the heating temperature is controlled based upon a determination result.

5. A method for manufacturing a glass fine particle deposited body using an apparatus which includes a burner, a vaporizer, a pipe which connects the vaporizer and the burner, a reaction vessel, and a starting rod disposed in the reaction vessel, the method comprising:
vaporizing liquid siloxane by the vaporizer to produce raw material gas;
heating the pipe at heating temperature of 230° C. or higher;
depositing a glass fine particle synthesized from the raw material gas sprayed from the burner on the starting rod to form the glass fine particle deposited body; and
integrally retracting the burner and the vaporizer as a diameter of the glass fine particle deposited body increases.
